(19) United States
(12) Patent Application Publication
(10) Pub. No.: US 2017/0054184 A1
(43) Pub. Date: Feb. 23, 2017

(54) LITHIUM ION SECONDARY BATTERY SYSTEM AND LITHIUM SECONDARY BATTERY SYSTEM OPERATION METHOD

(71) Applicant: NEC Corporation, Tokyo (JP)

(72) Inventors: Ayami TANABE, Tokyo (JP); Kazuhisa SUNAGA, Tokyo (JP); Osamu ISHIBASHI, Tokyo (JP); Hiroaki FUKUNISHI, Tokyo (JP); Kenji KOBAYASHI, Tokyo (JP)

(73) Assignee: NEC Corporation, Tokyo (JP)

(21) Appl. No.: 15/305,730

(22) PCT Filed: Apr. 15, 2015
(86) PCT No.: PCT/JP2015/002081

§ 371 Date: Oct. 21, 2016

(30) Foreign Application Priority Data
Apr. 24, 2014 (JP) 2014-089704

(51) Int. Cl. H01M 10/44; H02J 7/00; H01M 10/42; H01M 10/48; H01M 10/0525; H01M 10/46

(52) U.S. Cl. CPC H01M 10/44; H01M 10/0525; H01M 10/46; H01M 10/425; H01M 10/48; H02J 7/007; H02J 7/0063; H01M 2010/4271; H02J 2007/0067

(57) ABSTRACT

A lithium ion secondary battery system allowing a high power efficiency and large effective capacity is provided. The system includes an external power source for charging a lithium ion secondary battery, and a controller for switching output modes including a continuous discharge mode, in which electric power is continuously supplied from the lithium ion secondary battery to the load, and a pulsed charge and discharge mode, in which pulsed electric power is supplied from the lithium ion secondary battery to the load, and pulsed electric power is supplied from the external power source to charge the lithium ion secondary battery during a low-level pulsed discharge period(s), which are periods during which electric power is not supplied to the load, wherein the controller switches the output modes to the pulsed charge and discharge mode when the lithium ion secondary battery has a voltage lower than a predetermined upper switching voltage.

### TECHNICAL FIELD

The present invention relates to a lithium ion secondary battery system and an operation method of a lithium secondary battery system.

### BACKGROUND ART

Lithium ion secondary batteries have a drawback in that their effective dischargeable capacity decreases as electric current increases in proportion to their nominal capacity (See Patent Literature 1).

This is because a prolonged continuous discharge of a large current causes inhomogeneity in lithium ion distribution in a lithium ion secondary battery, which increases diffusion resistance of lithium ions, so that the voltage exceeds the upper limit (open-circuit voltage) or falls below the lower limit (discharge termination voltage).

To deal with this problem, Patent Literature 2 proposes a technique for making lithium ion distribution homogeneous. The proposed technique concerns intermittent charging or discharging of a lithium ion secondary battery.

Patent Literature 3 discloses a technique of decreasing the internal resistance of a lithium ion secondary battery by pulsed charge and discharge when the internal resistance exceeds a predetermined value.

### CITATION LIST

### Patent Literature

[PTL 1] Japanese Unexamined Patent Application Publication No. 2002-260673

[PTL 2] Japanese Unexamined Patent Application Publication No. 2004-171864

[PTL 3] Japanese Unexamined Patent Application Publication No. 2011-151943

### SUMMARY OF INVENTION

### Technical Problem

The technique disclosed in Patent Literature 2, however, does not sufficiently improve effective dischargeable capacity. For example, according to the technique, the effective capacity of a lithium ion battery having a nominal capacity 2 Ah is 0.98 Ah even when it is intermittently discharged at 20 C. This means that the battery can be used up to only less than half the nominal capacity of 2 Ah. Here, 1C refers to a current that would fully discharge a fully charged battery in one hour. For example, 20 C for a 0.98 Ah battery refers to a current of 19.6 A (0.98 * 20=19.6 A).

In addition, the technique disclosed in Patent Literature 2 may employ a switching means for switching between charge and discharge of pulsed current. If pulse control is exercised over the whole period of charging and discharging, switching loss that occurs at the switching means exacerbates and results in a declined power efficiency.

An object of the present invention is to provide a lithium ion secondary battery system and an operation method of a lithium secondary battery system that enable a high power efficiency and a large effective capacity.

### Solution to Problem

To solve the above problem, provided is an invention relating to a lithium ion secondary battery system configured to supply electric power from a lithium ion secondary battery to a load, the system comprising: an external power source for charging the lithium ion secondary battery; and a controller for switching output modes including a continuous discharge mode, in which electric power is continuously supplied from the lithium ion secondary battery to the load, and a pulsed charge and discharge mode, in which pulsed electric power is supplied from the lithium ion secondary battery to the load, and pulsed electric power is supplied from the external power source to charge the lithium ion secondary battery during a low-level pulsed discharge period(s), which are periods during which electric power is not supplied to the load, wherein the controller switches the output modes to the pulsed charge and discharge mode when the lithium ion secondary battery has a voltage lower than a predetermined upper switching voltage.

Provided also is an invention relating to an operation method of a lithium ion secondary battery system for supplying electric power from a lithium ion secondary battery to a load, the method comprising the steps of: detecting a voltage of the lithium ion secondary battery; acquiring an upper switching voltage as a reference point for a decision on switching output modes; and determining whether the voltage of the lithium ion secondary battery is lower than the upper switching voltage, and when the voltage of the lithium ion secondary battery is lower than the upper switching voltage, switching the output modes from a continuous discharge mode, in which electric power is continuously supplied from the lithium ion secondary battery to the load, to a pulsed charge and discharge mode, in which pulsed electric power is supplied from the lithium ion secondary battery to the load, and pulsed electric power is supplied from the external power source to charge the lithium ion secondary battery during one or more low-level pulsed discharge periods, which are periods during which no electric power is supplied from the lithium ion secondary battery to the load.

### Advantageous Effects of Invention

By switching to the pulsed charge and discharge mode under predetermined condition, the present invention improves discharge capacity while curbing electric power loss.

### BRIEF DESCRIPTION OF DRAWINGS

FIG. 1 is a block diagram illustrating a lithium ion secondary battery system according to a first example embodiment of the present invention.

FIG. 2 illustrates waveforms of a discharge current supplied to a load and of a charge current supplied to a battery.

FIG. 3 illustrates simulation results of discharge capacity for different output modes.

FIG. 4 illustrates the open-circuit voltage or closed-circuit voltage, reference voltage, upper switching voltage, lower switching voltage, and discharge termination voltage of a battery in relation to the discharge capacity of the battery.

FIG. 5 illustrates simulation results of discharge capacity for different tolerance values.

FIG. 6 is a flowchart illustrating a mode controlling process.

FIG. 7 illustrates waveforms of a discharge current supplied to a load and of a charge current supplied to a battery in a case where the battery is charged with a pulsed current which is supplied not throughout each low-level pulsed discharge period but merely during part of each period

FIG. 8 illustrates waveforms of a discharge current supplied to a load and of a charge current supplied to a battery in a case where the battery is charged with a pulsed current which is supplied during at least one of low-level pulsed discharge periods.

FIG. 9 is a graph for explaining a method of determining an upper switching voltage based on the slope of a discharge capacity characteristic.

### DESCRIPTION OF EXAMPLE EMBODIMENTS

Embodiments of the present invention will be described. cl First Example Embodiment

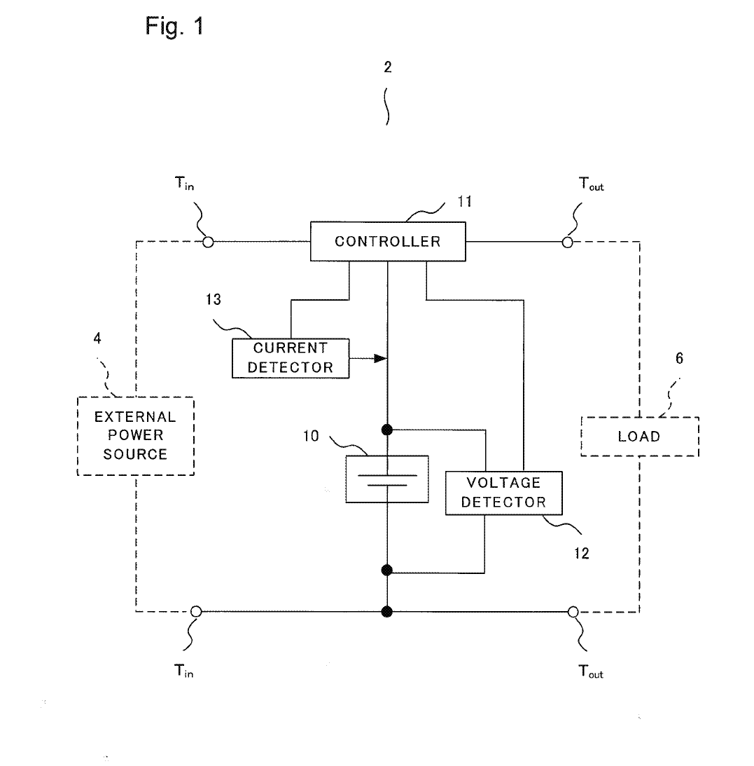

FIG. 1 is a block diagram illustrating a lithium ion secondary battery system 2 according to the present example embodiment. The lithium ion secondary battery system 2 includes a lithium ion secondary battery (hereinafter simply referred to a battery) 10, a controller 11, a current detector 13, a voltage detector 12, input terminals Tᵢₙ, output terminals Tₒᵤₜ.

The input terminals Tᵢₙ are connected with an external power source 4 provided with a charging function, and the output terminals Tₒᵤₜ are connected with a load 6. FIG. 1 illustrates the external power source 4 and the load 6 as well.

The load 6 is a heater, compressor, motor, refrigerator, or one of other apparatuses that run on a large amount of electric current.

The current detector 13 detects a discharge current from the battery 10 and a charge current supplied to the battery 10. The voltage detector 12 detects a voltage of the battery 10.

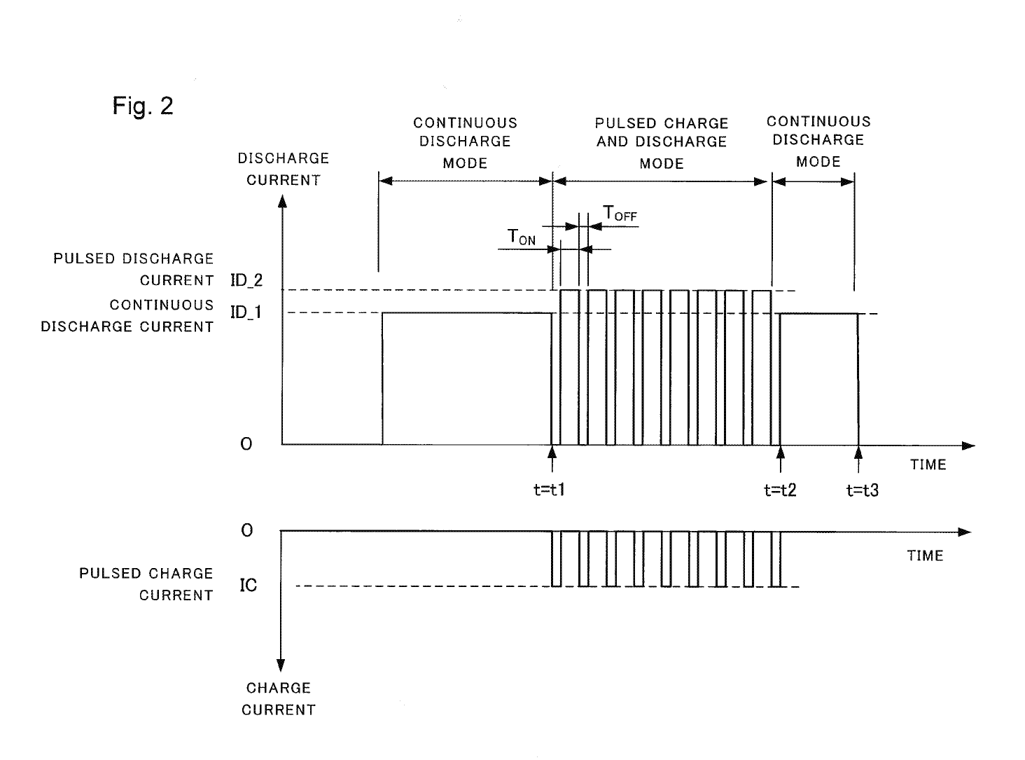

The battery 10 supplies electric power for the load 6 in output modes including a mode of discharging electric power continuously (the continuous discharge mode) and modes of discharging pulsed electric power (pulse modes). The pulse modes include a mode in which electric power is supplied from the external power source 4 to charge the battery 10 at a time when the pulse is at the low value (the pulsed charge and discharge mode) and a mode in which no electric power is supplied to the battery 10 at any time when the pulse is at the low value (the pulsed discharge mode). Herein, “a time when the pulse is at the low value” means a period T_{OFF} in FIG. 2, and such a period is hereafter referred to as a “low-level pulsed discharge period”.

FIG. 2 illustrates waveforms of a discharge current supplied to the load 6 and of a charge current supplied to the battery 10. In FIG. 2, ID_1 is an average discharge current supplied to the load 6 in the continuous discharge mode and ID_2 is the peak value of a pulsed current supplied to the load 6 in the pulsed charge and discharge mode. IC is the peak value of a current supplied to the battery 10 in the pulsed charge and discharge mode. Hereinbelow, ID_1 will be referred to as a continuous discharge current, ID_2 a pulsed discharge current, and IC a pulsed charge current.

A pulsed discharge current ID_2 is determined based on a continuous discharge current ID_1 so as to satisfy the equation 1.

ID_2=ID_1*(T_{ON}+T_{OFF})/T_{ON} (1)

wherein T_{ON} is a period during which the pulse waveform is at the high value, T_{OFF} is a period during which the pulse waveform is at the low value (a low-level pulsed discharge period). The equation 1 signifies that the electric power supplied to the load 6 by pulsed discharge during one cycle of the pulsed discharge (ID_2 * T_{ON}) is equal to the electric power supplied to the load 6 by continuous discharge for the same duration (ID_1 * (T_{ON}+T_{OFF}).

The pulsed charge and discharge mode is employed when the voltage V_{B} of the battery 10 is between an upper switching voltage V_{U} and a lower switching voltage V_{L}. In FIG. 2, since the voltage V_{B} of the battery 10 falls below the upper switching voltage V_{U} at a time t=t1, the output modes are switched from the continuous discharge mode to the pulsed charge and discharge mode. At a time t=t2, since the voltage V_{B} falls below the lower switching voltage V_{L}, the output modes are switched from the pulsed charge and discharge mode to the continuous discharge mode. Here, a time t=t3 is the time when the voltage V_{B} reaches a discharge termination voltage V_{T}.

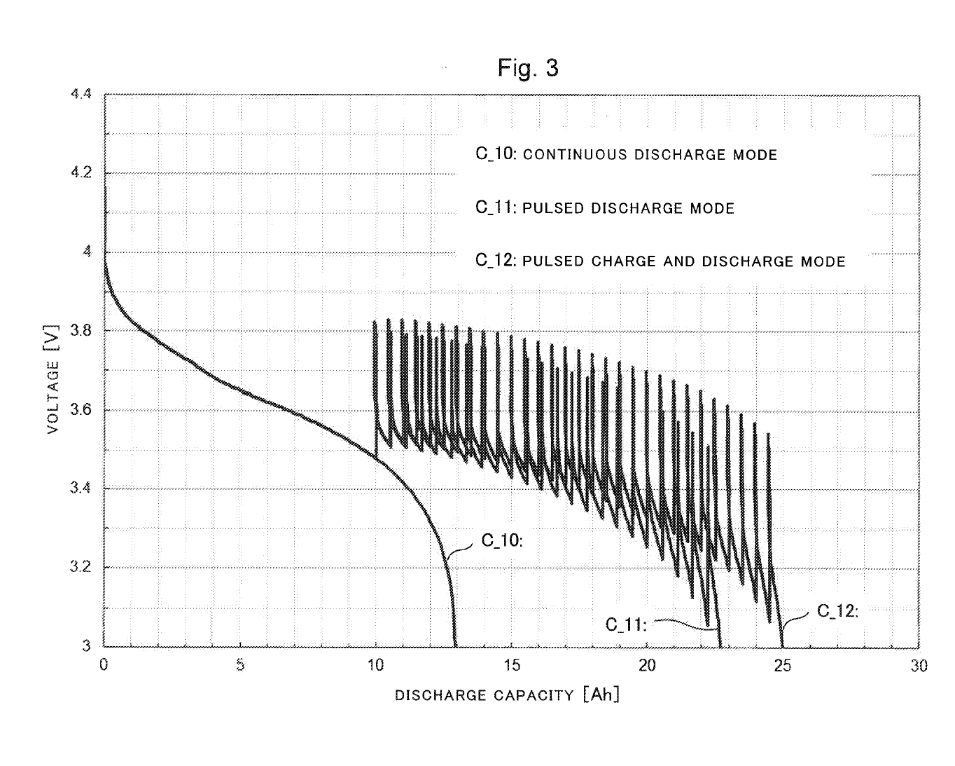

FIG. 3 illustrates simulation results of discharge capacity for different output modes (the continuous discharge mode, the pulsed discharge mode, and the pulsed charge and discharge mode). The horizontal axis represents discharge capacity. The vertical axis represents the closed-circuit voltage of the battery.

In these simulations, the battery 10 had a capacity of 32.5 Ah and the discharge termination voltage was set at 3.0V. FIG. 3 shows the discharge capacity in the cases of: a continuous discharge at 6.25 C (the curve C_10), a pulsed discharge (the curve C_11), a pulsed charge and discharge (the curve C_12).

According to the simulation results, the discharge capacity was 12.94 Ah in the continuous discharge mode, 22.73 Ah in the pulsed discharge mode, and 25.00 Ah in the pulsed charge and discharge mode. In other words, switching from the continuous discharge mode to the pulsed discharge mode led to an improvement of 9.79 Ah (=22.73−12.94) in discharge capacity, and switching from the continuous discharge mode to the pulsed charge and discharge mode led to an improvement of 12.06 Ah (=25.00−12.94) in discharge capacity. Further, switching to the pulsed charge and discharge mode improved discharge capacity 1.23 times as much as switching to the pulsed discharge mode. It is confirmed from the above that switching from the continuous discharge mode to the pulsed charge mode greatly improves discharge capacity.

In switching to the pulsed charge and discharge mode as described above, timings of switching the modes are important for curbing switching loss (for improving power efficiency). In the present example embodiment, as described above, an upper switching voltage V_{U} and a lower switching voltage V_{L} are determined, and the pulsed charge and discharge mode is employed when the voltage of the battery 10 is in the range therebetween, otherwise the continuous discharge mode is employed.

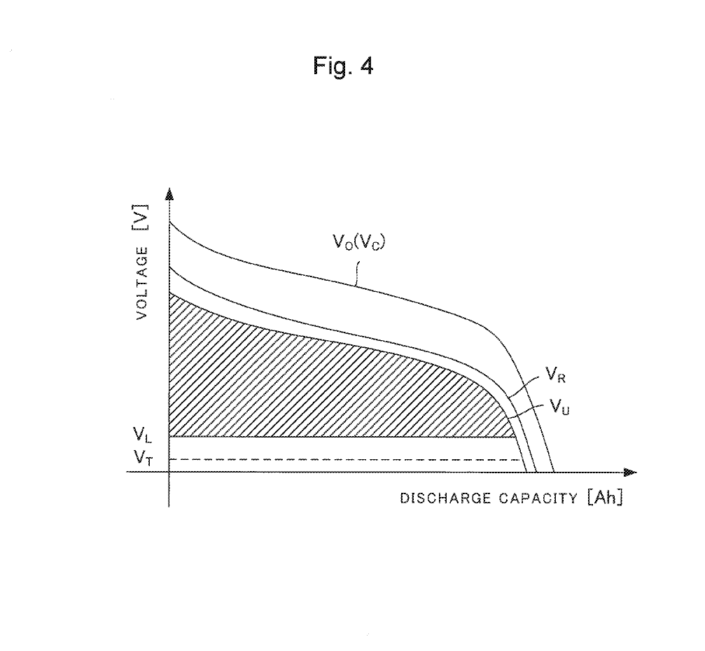

As the upper switching voltage V_{U} needs to be calculated, referring to FIG. 4, a method of calculating V_{U} will be described blow. FIG. 4 illustrates the open-circuit voltage V_{O} or closed-circuit voltage V_{C}, reference voltage V_{R}, upper switching voltage V_{U}, lower switching voltage V_{L}, and discharge termination voltage V_{T}, in relation to discharge capacity of the battery. The area shaded with oblique lines in the FIG. 4 denotes the range in which the inequality V_{L}≦V_{B}≦V_{U} holds, V_{L} being the lower switching voltage and V_{U} being the upper switching voltage. In other words, when the voltage V_{B} of the battery 10 is in this range, the pulsed charge and discharge mode is employed.

An upper switching voltage V_{U} is defined by the equation 2,

V_{U}=V_{R}*α (2)

wherein V_{R} is a reference voltage defined by:

V_{R}=Vₓ−(I−Iₓ)*R_{O} (3)

wherein I is the output current flowing between the Tₒᵤₜ terminals. The reference voltage is equal to the electromotive force minus the voltage drop due to the internal resistance of the battery 10, and corresponds to the terminal voltage of the battery 10.

Here, Vₓ is the open-circuit voltage V_{O} of the battery 10 or a closed-circuit voltage V_{C} of the battery 10 at a low rate discharge (not more than 1 C). When Vₓ=V_{O}, Iₓ is the current I_{O} at the time of detection of V_{O}, and R_{O} is the internal resistance of the battery 10 at the time of detection of V_{O}. Since V_{O} is the open-circuit voltage, I_{O}=0 in this case. When Vₓ=V_{C}, Iₓ is the current I_{C} at the time of the detection of V_{C}.

α is a tolerance value (ratio) showing the degree to which the voltage is allowed to deviate from the reference voltage V_{R}, and preferably α≧0.9, judging from the simulation results to be described below.

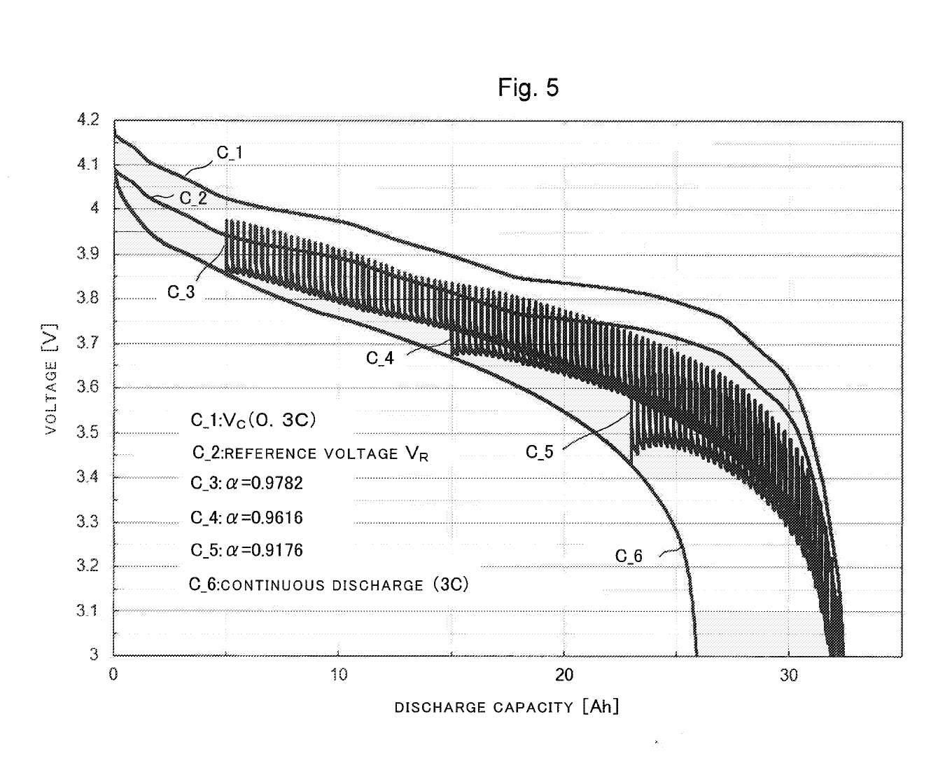

FIG. 5 illustrates simulation results of discharge capacity for different tolerance values α. The curve C_1 is the characteristic curve of the closed-circuit voltage with a discharge capacity of 32.41 Ah at 0.3 C. The curve C_2 is the characteristic curve of the reference voltage V_{R} with a discharge capacity of 32.30 Ah at 3 C. The curves C_3 to C_5 represent discharge capacity characteristics of pulsed discharge at 3 C, respectively with a discharge capacity of 31.91 Ah and a tolerance value α=0.9782, with a discharge capacity of 31.86 Ah and a tolerance value α=0.9616, and with a discharge capacity of 31.88 Ah and a tolerance value α=0.9176. The curve C_6 represents the discharge capacity characteristic of continuous discharge at 3 C with a discharge capacity of 5.91 Ah.

As illustrated in FIG. 5, when the pulsed charge and discharge mode is employed with a tolerance value a larger than 0.9000, the differences of discharge capacity of the curves C_3 to C_5 fell within a range of 2% or less of the discharge capacity of the curve C_1. Although not shown, where the tolerance value α is smaller than 0.9000, the discharge capacity decreased as the tolerance value α increased. Accordingly, the tolerance value α is preferably larger than 0.9000 for improvement of discharge capacity. When a semiconductor switch is used for switching to the pulsed charge and discharge mode, preferably a tolerance value α≈0.9000 is used in order to minimize the power loss at the semiconductor switch.

Next, a method of calculating the lower switching voltage V_{L} will be described. The lower switching voltage V_{L} is defined by the equation 4 as the sum of the discharge termination voltage V_{T} of the battery 10 and a drop voltage ΔV accompanying the pulsed discharge,

V_{L}=V_{T}+ΔV (4)

wherein, the drop voltage αV is defined by the equation 5,

ΔV=(ID_2−ID_1)*R_{O}*β (5)

wherein β is a coefficient of proportionality and preferably β=1.0 to 1.2.

When pulsed discharge current is controlled so that the average pulsed discharge current over one cycle (average current) is equal to the continuous discharge current (when the equation 1 is satisfied), the peak of the current in the pulsed discharge mode is higher than the continuous discharge current (ID_2>ID_1). By Ohm's law, a larger current means a lower voltage. Therefore, a continuous discharge current ID_1 and a pulsed discharge current ID_2 that satisfy the equation 1 would result in the voltage falling of the discharge termination voltage due to the high discharge capacity. To avoid this, when the voltage V_{B} of the battery 10 falls below the lower switching voltage V_{L} (V_{B}<V_{L}), the controller 11 switches the modes from the pulsed charge and discharge mode to the continuous discharge mode to curtail the peak current and prevent the voltage from falling to the discharge termination voltage, thereby increasing the discharge capacity.

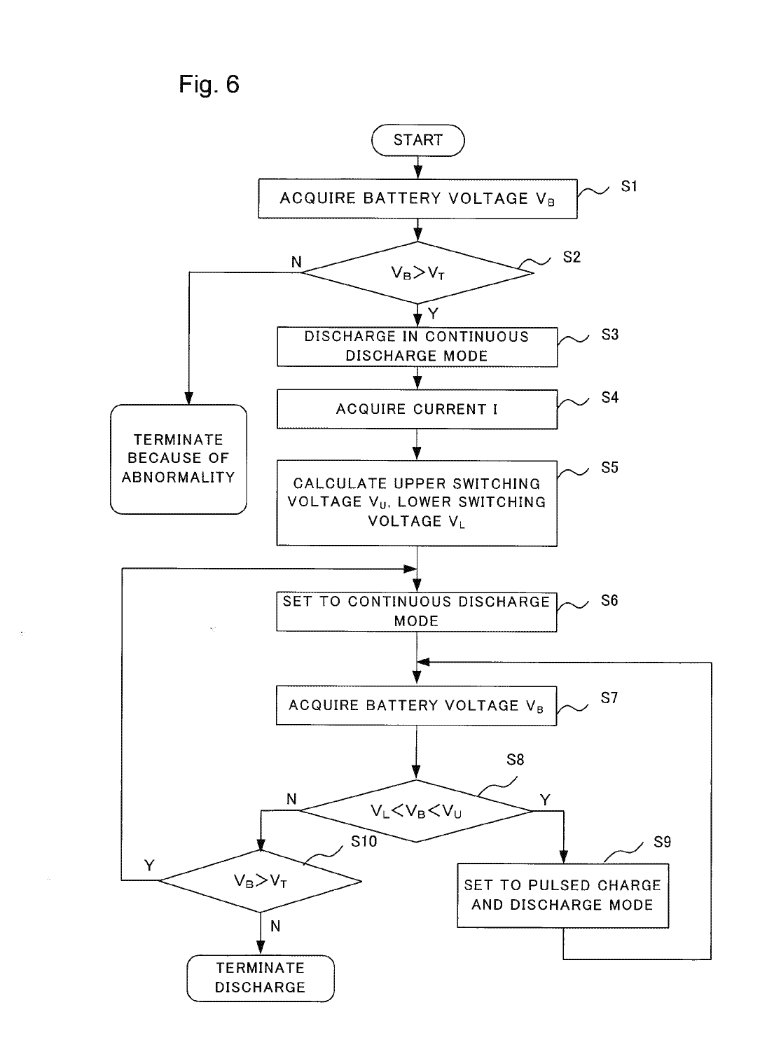

Referring to FIG. 6, mode controlling process performed by the controller 11 will be described. FIG. 6 is a flowchart illustrating a mode controlling process.

### (Steps S1, S2)

First, the controller 11 acquires from the voltage detector 12 a voltage V_{B} of the battery 10 and determines whether V_{B} is greater than the discharge termination voltage V_{T}. When the voltage V_{B} is equal to or smaller than the discharge termination voltage V_{T} (V_{B}≦V_{T}), this means that the battery 10 has no available capacity and the process terminates because of the abnormality. Needless to say, the controller 11 may output a message notifying the capacity shortage in such a case.

### (Steps S3, S4)

When the battery 10 has an ample discharge capacity (V_{B}>V_{T}), the controller 11 conducts discharge in the continuous discharge mode and acquires from the current detector 13 the current I at the time.

### (Step S5)

Next, an upper switching voltage V_{U} and a lower switching voltage V_{L} are calculated. Note that, according to the description of the present example embodiment, the upper switching voltage V_{U} and the lower switching voltage V_{L} are calculated after the commencement of the process, but alternatively they are calculated in advance and stored in a memory or the like. Methods for calculating an upper switching voltage V_{U} and a lower switching voltage V_{L} will be described later.

### (Steps S6, S7)

The controller 11 sets the output mode to the continuous discharge mode and starts discharge. The controller 11 acquires the voltage V_{B} of the battery 10 as soon as the discharge starts.

### (Step S8)

The controller 11 then determines whether the acquired voltage V_{B} is between the upper switching voltage V_{U} and the lower switching voltage V_{L}.

### (Step S9)

When the voltage V_{B} is in the range between the upper switching voltage V_{U} and the lower switching voltage V_{L}, exclusive of V_{U} and V_{L} (V_{L}<V_{B}<V_{U}), the controller 11 switches the output modes to the pulsed charge and discharge mode and returns to Step S7.

### (Step S10)

When the voltage V_{B} is not in the range between the upper switching voltage V_{U} and the lower switching voltage V_{L} (V_{B}<V_{T}, V_{B}>V_{U}), the controller 11 determines whether the V_{B} is greater than the predetermined discharge termination voltage V_{T}. Here, when the voltage V_{B} is greater than the discharge termination voltage V_{T} (V_{B}>V_{T}), the controller 11 returns to Step S6 and set the output mode to the continuous discharge mode. When the voltage V_{B} is equal to or smaller than the discharge termination voltage V_{T} (V_{B}≦V_{T}), the controller 11 terminates the discharge.

As describe above, switching the output modes to and from the pulsed charge and discharge mode under predetermined conditions improves discharge capacity while curbing power losses.

### Second Example Embodiment

Next, a second example embodiment will be described. Same reference numerals will be assigned to same elements described in the first example embodiment, and description thereof will be omitted where appropriate.

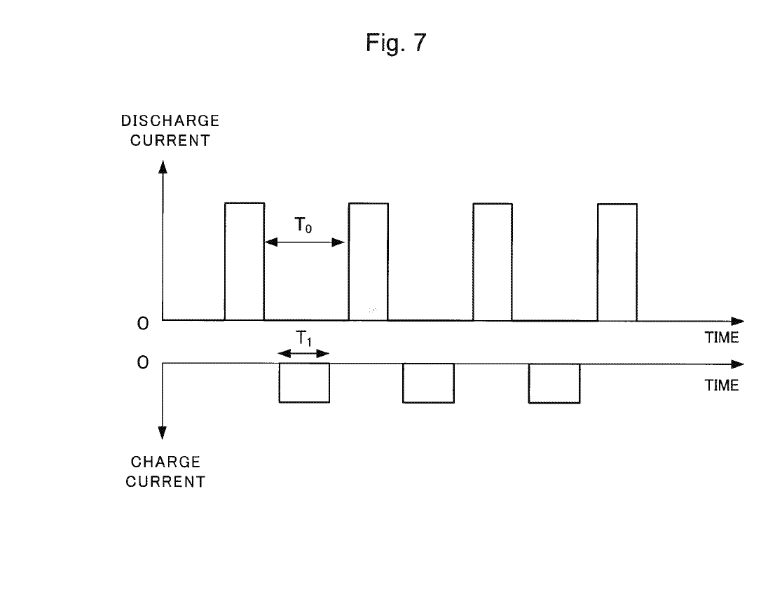

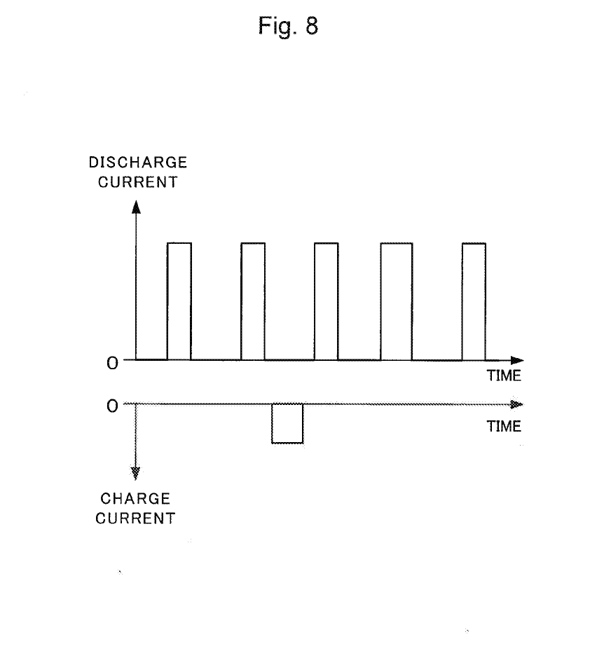

In the pulsed charge and discharge mode in the first example embodiment, pulsed current for charging the battery is supplied from the external power source 4 for all the low-level pulsed discharge periods as illustrated in FIG. 2. The present invention, however, is not limited to this manner and the battery may be charged with a pulsed current, for example, as illustrated in FIGS. 7 and 8.

Specifically, according to the method illustrated in FIG. 7, the battery is charged with a pulsed current not throughout each low-level pulsed discharge period T₀, but during a portion T₁ of each period (T₀>T₁).

Further, according to the method illustrated in FIG. 8, the battery is charged with a pulsed current during at least one of the low-level pulsed discharge periods.

An appropriate method may be selected in accordance with the capacity of the external power source 4 or desired discharge current.

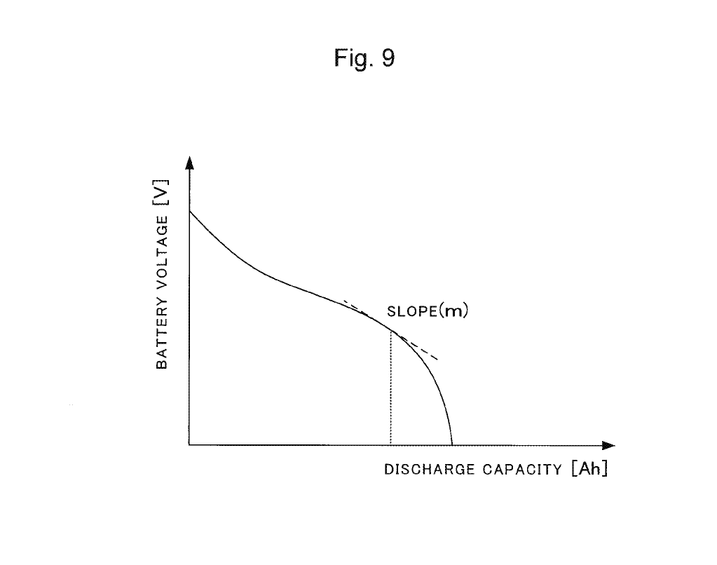

While in the first example embodiment, the upper switching voltage V_{U} is calculated by the equation 2, the present invention is not limited to using such a method. As illustrated in FIG. 9, the upper switching voltage V_{U} may be set, for example, to be equal to the voltage at which the slope of the discharge capacity characteristic curve during the continuous discharge takes a predetermined value.

The value of slope m may be selected so as to be in a range where diffusion resistance due to inhomogeneity of lithium ion distribution does not occur, for example, −0.1≦m≦−0.02. Suppose, for example, the slope m is set at m=−0.02. When the voltage of the battery reaches the point where the slope takes this value, the output modes are switched from the continuous discharge mode to the pulsed charge and discharge mode, and when the voltage of the battery reaches the lower switching voltage V_{L}, the modes are switched from the pulsed charge and discharge mode to the continuous discharge mode. This allows to achieve the same effects as in the first example embodiment.

Although the present invention has so far been described with reference to example embodiments (and examples), the present invention is not limited to the above example embodiments (and examples). Various modifications that those skilled in the art can understand may be made to the structure and detail of the present invention without departing from the scope of the invention.

The present application claims priority of the Japanese Patent Application No. 2014-089704 filed on Apr. 24, 2014, the disclosure of which is incorporated herein in its entirety by reference.

### REFERENCE SIGNS LIST

2 lithium ion secondary battery system

4 external power source

6 load

10 battery

11 controller

12 voltage detector

13 current detector

1. A lithium ion secondary battery system configured to supply electric power from a lithium ion secondary battery to a load, the system comprising:
an external power source that charges the lithium ion secondary battery; and
a controller that switches output modes including a continuous discharge mode, in which electric power is continuously supplied from the lithium ion secondary battery to the load, and a pulsed charge and discharge mode, in which pulsed electric power is supplied from the lithium ion secondary battery to the load, and pulsed electric power is supplied from the external power source to charge the lithium ion secondary battery during at least one of low-level pulsed discharge periods, which are periods during which electric power is not supplied to the load,
wherein the controller switches the output modes to the pulsed charge and discharge mode when the lithium ion secondary battery has a voltage lower than a predetermined upper switching voltage.

2. The lithium ion secondary battery system according to claim 1, wherein the controller switches the output modes to the continuous discharge mode when the voltage is higher than the predetermined upper switching voltage or lower than a predetermined lower switching voltage.

3. The lithium ion secondary battery system according to claim 1, wherein, in the pulsed charge and discharge mode, power is supplied from the external power source to charge the lithium ion secondary battery during the low-level pulsed discharge periods.

4. The lithium ion secondary battery system according to claim 1, wherein, during the low-level pulsed discharge period(s), power is supplied from the external power source to the lithium ion secondary battery system for a period shorter than the respective low-level pulsed discharge period(s).

5. The lithium ion secondary battery system according to claim 1, wherein a pulsed current discharged in the pulsed charge and discharge mode has an average over each cycle equal to a continuous discharge current in the continuous discharge mode.

6. The lithium ion secondary battery system according to claim 1, wherein the upper switching voltage is 0.90-0.98 times a reference voltage, which is a maximum voltage at which electric power is discharged from the lithium ion secondary battery.

7. The lithium ion secondary battery system according to claim 1, wherein the upper switching voltage is equal to a voltage of the lithium ion secondary battery such that m satisfies −0.1≦m≦−0.02, wherein m is a rate of change of voltage to discharge capacity of the lithium ion secondary battery.

8. The lithium ion secondary battery system according to claim 2, wherein the lower switching voltage is equal to a sum of a discharge termination voltage of the lithium ion secondary battery and a voltage drop during pulsed discharge.

9. An operation method of a lithium ion secondary battery system for supplying electric power from a lithium ion secondary battery to a load, the method comprising:
detecting a voltage of the lithium ion secondary battery;
acquiring an upper switching voltage as a reference point for a decision on switching output modes;
determining whether the voltage of the lithium ion secondary battery is lower than the upper switching voltage, and
when the voltage of the lithium ion secondary battery is lower than the upper switching voltage, switching the output modes from a continuous discharge mode, in which electric power is continuously supplied from the lithium ion secondary battery to the load, to a pulsed charge and discharge mode, in which pulsed electric power is supplied from the lithium ion secondary battery to the load, and pulsed electric power is supplied from the external power source to charge the lithium ion secondary battery during a pulsed discharge period(s), which are periods during which electric power is not supplied to the load.

10. The operation method of a lithium ion secondary battery system according to claim 9, the method further comprising
acquiring a lower switching voltage as a reference point for a decision on switching between output modes, and
switching the output modes to the continuous discharge mode when the voltage of the lithium ion secondary battery is higher than the upper switching voltage or lower than the lower switching voltage.

11. The operation method of a lithium ion secondary battery system according to claim 9, wherein in the pulsed charge and discharge mode, power is supplied from the external power source to charge the lithium ion secondary battery during at least one of the low-level pulsed discharge periods.

12. The operation method of a lithium ion secondary battery system according to claim 9, wherein, during the low-level pulsed discharge period(s), power is supplied from the external power source to the lithium ion secondary battery system for a period shorter than the respective low-level pulsed discharge period(s).

13. The operation method of a lithium ion secondary battery system according to claim 9, wherein a pulsed current discharged in the pulsed charge and discharge mode has an average over each cycle equal to a continuous discharge current in the continuous discharge mode.

14. The operation method of a lithium ion secondary battery system according to claim 9, wherein the upper switching voltage is 0.90-0.98 times a reference voltage, which is a maximum voltage at which electric power is discharged from the lithium ion secondary battery.

15. The operation method of a lithium ion secondary battery system according to claim 9, wherein the upper switching voltage is equal to a voltage of the lithium ion secondary battery such that m satisfies −0.1≦m≦−0.02, wherein m is a rate of change of voltage to discharge capacity of the lithium ion secondary battery.

16. The operation method of a lithium ion secondary battery system according to claim 9, wherein the lower switching voltage is equal to a sum of a discharge termination voltage of the lithium ion secondary battery and a voltage drop at a time of pulsed discharge.
